(19) United States
(12) Patent Application Publication
(10) Pub. No.: US 2007/0286919 A1
(43) Pub. Date: Dec. 13, 2007

(54) Unit for Compression Moulding Articles of Polymer Material

(75) Inventors: Fiorenzo Parrinello, Medicina (IT); Zeno Zuffa, Borgo Tossignano (IT)

Correspondence Address: BROWDY AND NEIMARK, P.L.L.C.;624 NINTH STREET, NW, SUITE 300, WASHINGTON, DC, 20001-5303, US

(73) Assignee: Sacmi Copperativa Meccanici Imola Societa' Cooperativa, Imola (IT)

(21) Appl. No.: 11/664,461

(22) PCT Filed: Aug. 3, 2005
(86) PCT No.: PCT/IB05/02303

§ 371 Date: Apr. 2, 2007

(30) Foreign Application Priority Data
Oct. 12, 2004 (IT) RE2004A000128

(51) Int. Cl. B29C 43/36

(52) U.S. Cl. 425/352; 264/319

(57) ABSTRACT

The unit operates by coupling together under pressure a punch (11) and a die with its closed cavity loaded with a charge of polymer material, the charge being produced outside the die and then inserted into the die cavity. The unit comprises a mould having a lower die part arranged to form the lower part of the outer surface of the article, the inner surface (30a) of which comprises a lower end portion and an axially extending lateral portion. The lower die part (30) comprises a first constituent member (31) and a second constituent member (32) having inner surfaces (33, 34) which can be complementarily aligned to together define the inner surface (30a) of the lower die part (30); the inner surface (34) of the second constituent member (32) defines totally or to a large extent said lower end portion of the inner surface of the lower die part (30). The second constituent member (32) is movable relative to the first constituent member (31) between an upper position in which its inner surface (34) lies in said position aligned with the inner surface (33) and a withdrawn position in which its inner surface (34) lies spaced from the inner surface (33) in order to increase the volume of the cavity of the lower die part (30).

### TECHNICAL FIELD

The present invention relates generally to the compression moulding of articles of polymer material by coupling together under pressure a punch and a die to form a closed cavity loaded with a charge of polymer material, in which the charge is initially produced outside the die and is then inserted into the die cavity.

The unit comprises a mould having a die presenting a lower part for forming the lower part of the outer surface of the article, the inner surface of which is formed by a lower end portion and an axially extending lateral portion.

### BACKGROUND ART

A first technical problem to be solved arises from the fact that the charge, whether in the substantially molten or in the more or less viscous state, is dispensed from the dispensing port while this is in a position outside the die cavity and is then inserted into the die interior.

The problem is to prevent the charge, during insertion, from coming into contact with the lateral region of the die cavity and hence avoid the charge descending with difficulty, or incorrectly, or not descending, into the die. In moulding many articles, such a problem does not exist at all; this is so when moulding plastic closure caps for large or small bottles or for containers in general, in which the diameter of the die cavity base, which extends in a horizontal plane, is greater than its height (see for example WO 01/34362), and the charge, because of the small thickness of the article, has a volume so small compared with the cavity that any problem in inserting this charge into the die cannot even be perceived.

In contrast, the problem is felt if the die cavity is of particularly narrow and axially (vertically) elongated shape and the charge has a relatively large volume.

In such cases it is desirable to produce charges having a diameter much narrower than the minimum cross-section diameter of the die cavity so that they can descend correctly along the cavity as far as its bottom; unfortunately, in such cases it can happen that the height of the charge is excessive compared with the axial dimension of the die cavity, so that if the charge is of sufficiently viscous consistency, it projects unacceptably from the die to prevent correct execution of the operations, in particular preventing correct mould closure when its components are made to approach each other into contact.

Other problems occur if the punch operates by penetrating a large extent into the die cavity; in this case the punch in deforming the charge can cause lifting of its upper parts, with leakage from the top of the cavity before the mould has completely closed.

Other charge-containing problems occur if the die is formed from at least two separate components, an upper and a lower, which are brought together after introducing the charge. In this case, in one operative stage the charge is contained in only the lower part of the die, hence this lower part must be designed with a height and capacity sufficient to adequately contain the charge and prevent the charge, as aforestated, from projecting unacceptably out of the die and prevent correct mould closure.

An object of the present invention is generally to solve said technical problems.

A typical though non-exclusive application of the invention is to form preforms (semifinished articles) of polymer material for the subsequent production (typically by stretch blow moulding) of containers of polymer material, the preform being moulded by pressure-inserting a punch (male mould element) into a hollow die (female mould element) loaded with a charge of solid, pasty or liquid material, in particular a thermoplastic resin, the preform comprising in an upper position a neck provided with projections and further comprising a hollow body joined to the neck. In this case the invention relates typically to a moulding unit used in a machine with a rotating turntable (typically driven continuously), operating typically with a plurality of identical moulding units driven in sequence. The term “driven in sequence” means herein that for each angular position of a unit (or of a plurality of units operating simultaneously) there corresponds an unequivocal operative configuration of the unit (or of the plurality of units) and that as a result of rotating the turntable, each unit undergoes an operative cycle; this operative cycle can be accomplished either through one complete revolution of the turntable or through fractions of a revolution.

According to said typical application, the unit of the invention comprises a mould having:

an upper die part with its inner surface arranged to form the outer surface of the upper neck and being divided into at least two sectors able to be withdrawn apart to extract the preform,

a lower die part with its inner surface arranged to form the outer surface of the preform hollow body,

and a punch with its outer surface arranged to form the inner surface of the preform,

the cavities of said upper and lower die parts being arranged, when operatively associated with each other, to form, together with the punch, the mould cavity.

In this typical application, the aforedescribed technical problems connected with containing the charge within the die are amplified.

The particularly sharp-edged shape of the upper die part tends to restrain the charge when making contact with it.

Moreover, as the mould is rotated at high speed, centrifugal thrusts occur which tend to displace the trajectory of the charge descending into the die away from the exactly vertical trajectory which occurs in the static condition.

These factors mean that the charge has to be made as thin as possible compared with the die cavity diameters to prevent the charge from coming into contact with it and remaining stuck.

Consequently, if the charge is of sufficiently viscous consistency it will because of its small diameter have a considerable axial length (height) to the extent that, for some models, it is greater than the height of the cavity into which it is introduced and hence projects externally upwards. This presents problems and/or complications in bringing the mould parts into contact during closure because the charge can project out of the cavity, including in a radial direction, and hence hinder and prevent correct mould operation.

Moreover, for this typical application of the invention, because of the high operative speeds of the rotating turntable machine, the speed with which the punch penetrates into the die where it deforms the charge is very high (the moulding operation takes just a few tenths of a second); there is thus the danger that the upper end parts of the charge become propelled out of the die cavity before it has been closed by the punch, with consequent serious irregularities and obstacles for the correct operation of the machine.

According to one embodiment of said typical application, in the first moulding stage, a charge (i.e. a body of predetermined mass) of polymer material is inserted into the cavity of the lower die part, while the upper die part is positioned spaced above the lower part. The upper die part is then moved towards and hence associated with the upper edge of the lower die part to form therewith the complete die cavity, after which the punch is made to penetrate into this cavity.

In particular, for preforms of relatively small mass, i.e. to produce containers of relatively small capacity (for example less than about 0.3 litres), the mass of the neck is relatively large compared with the mass of the hollow body, hence the mass of the entire preform is relatively high compared with the containing capacity of the lower die part; it can therefore happen that the charge is not completely contained within the cavity of the lower die part, whether of substantially liquid form or of more or less viscous elongated cylinder form.

To solve the described problems related to charge containment, various patents are known (JP 2003-159739, U.S. Pat. No. 6,349,838, JP 2000-25729 and others) relative to the moulding of preforms for plastic containers in which the die cavity is given a particularly downwardly convergent shape, to reduce the risk of contact between the charge and the die lateral surface in the upper region; in this manner the charge can be given a relatively large diameter to the extent of preventing it from projecting out of the cavity.

However the shape given to the preform is fairly conical and is hence not optimal for the subsequent moulding of containers as these generally have a substantially cylindrical body. An object of the present invention is generally to solve this technical problem.

A second technical problem connected with units for compression moulding articles of polymer material, in particular where applied to a machine operating at high speed, derives from the fact that the charge inevitably presents (small) mass differences compared with the predetermined value, while the volume of the mould chamber, which must be completely filled by the charge to form the article, remains exactly constant (with reference to the said mould); there is therefore the problem of compensating the inaccuracy of the mass of the charge produced during its dispensing.

WO 01/34362 describes a mould for compression moulding container closure caps in which the upper punch possesses an additional movable part maintained pressed downwards by thrust means. During moulding, the excess mass of the charge upwardly urges said additional part to overcome the pressure produced thereby, hence compensating the inaccuracy of the charge mass. The die also possesses an additional movable part in a position below the additional part of the punch, which however is operated with a fixed stroke and can hence not act as a means for compensating the charge inaccuracy, and if it were to do this it would leave an unacceptable impression on the outer surface of the cap.

Another object of the invention is to provide a valid solution to this second technical problem.

Another technical problem connected with moulds of the invention is to control and accompany, after moulding and while the article in the mould is cooling, the specific volume variations caused by the decreasing temperature, in order to maintain its mass compact, uniform and free of irregularities, cavities or shrinkages.

A further technical problem relates to the need to draw out the air present in the mould cavity before the material is completely compressed.

A further technical problem relates to the need to improve the detachment of the moulded article from the die surface.

Finally, a further technical problem relates to the need to accelerate the cooling of the moulded article.

Another object of the present invention is to improve known moulds with reference to the aforestated technical problems.

### DISCLOSURE OF THE INVENTION

These and further objects are attained by the present invention as characterised in the claims.

According to the invention, the lower die part comprises a first constituent member and a second constituent member having internal surfaces which can be complementarily aligned, i.e. which can be mutually disposed to form a single continuous or nearly continuous surface defining the entire inner surface of the lower die part (position known herein as the “upper position”); the inner surface of the second constituent member defines totally or to a large extent the lower end portion of the inner surface of the lower die part. Moreover, said second constituent member is movable relative to the first constituent member between said upper position and a position known herein as the “withdrawn position”, in which its inner surface lies distant from the surface of the first constituent member in order to increase the volume of the cavity of the lower die part. Finally, the unit comprises operating means to dispose said second constituent member in said withdrawn position during the stage of loading a charge of polymer material into the cavity of the lower die part and to bring it into its upper position during the moulding stage.

In moulding the preform in accordance with the typical application of the invention, the unit of the invention operates with the following stages:

preparing a charge outside the die;

inserting a charge into the cavity of the lower die with the second constituent member in its withdrawn position;

then progressively inserting the punch into the die cavity until the mould is completely closed;

moving the second constituent member into its upper position, this movement starting with a time delay on the punch penetration so that no part of the charge can escape from the die cavity before this is completely closed. When the second constituent member is in its withdrawn position, the cavity of the lower die part has a capacity substantially greater than a traditional lower die part, to the extent that it can be dimensioned to contain charges having a relatively very large axial dimension.

Moreover, the cavity of the lower die part has a variable volume, which can be suitably used to compensate the error in dispensing the charge mass.

This aspect can also be used to control and follow the material volume reduction during cooling.

It has also been found that, with the present invention, during the moulding operation the charge mass attains relatively complete and homogeneous filling of the mould cavity, without unacceptable tensions and imperfections, especially with regard to the upper end of the neck which, during moulding, represents the most critical region.

Finally, by providing between the body surfaces an interstice connected to lower end of the mould cavity, air or other fluids can be inserted and/or extracted to improve the moulding stage and/or the subsequent stages of cooling the article or extracting it from the mould cavity.

### BRIEF DESCRIPTION OF THE DRAWINGS

The invention is described in detail hereinafter with the aid of the accompanying figures which illustrate one embodiment thereof by way of non-exclusive example.

FIG. 1 is an axial section through the unit of the invention (the mould cavity 7 is shown empty).

FIG. 1A is an enlarged detail of FIG. 1.

FIG. 2A shows the upper portion of FIG. 1 on an enlarged scale.

FIG. 2B shows the lower portion of FIG. 1 on an enlarged scale.

FIG. 2C is an enlarged detail of FIG. 2B.

FIGS. 3A-3G show the unit of FIG. 1 in a succession of stages in the moulding of the preform.

FIG. 4 shows an example of the preform obtained with the invention.

FIG. 5 shows the unit of FIG. 1 while detaching the preform from the die.

### DETAILED DESCRIPTION OF THE INVENTION

The unit of the invention comprises a mould having a die and a punch. Together, the punch and the die cavity give rise to a closed chamber within which the article is given shape by the compression operated within the mould.

According to a typical application of the invention, the article to be moulded is a preform 9 intended for the subsequent production of containers (typically by stretch blow moulding).

An example of a preform to be obtained by the invention is shown in FIG. 4. This preform, indicated by 9, is used to produce bottles of PET thermoplastic resin and comprises a neck 91 having the final form required on the bottle, and a hollow body 92 intended to form the container body of the bottle during its production stage. Generally, the neck 91 is provided with projections which define, for example, a thread 93 projecting radially outwards to receive a usual screw cap. The hollow body 92 has a generally quasi-cylindrical continuous outer surface (slightly tapered downwards for mould extraction reasons) terminating at its lower end with a more or less spherical cap.

The article (in particular the preform 9) is obtained by a compression moulding procedure by pressure-inserting a punch 11 (male mould element) into the cavity of a hollow die (female mould element) loaded with a polymer material charge 8 of predetermined mass (the same as the preform to be obtained) of material (solid, pasty or liquid), in particular a thermoplastic resin.

The moulding machine using the unit of the invention is typically of the rotating turntable type, typically operating continuously, and operates typically with a plurality of identical moulding units which are operated in sequence.

The figures show only one generic unit of the invention. The machine is not illustrated, being of traditional type.

According to the embodiment shown in the figures, the unit of the invention comprises a mould having a die and a punch 11. Together, the punch 11 and the die cavity give rise to a closed chamber 7, within which the preform 9 is moulded. The die cavity gives shape to the outer surface of the preform while the outer surface of the punch 11 gives shape to the inner surface of the preform.

The mould die is formed from an upper part 20 and a lower part 30. In other cases (not shown in the figures) the die can be formed as a single body.

The upper die part 20 has an inner surface 21 arranged to form the outer surface of the upper neck 91 of the preform, and is divided into at least two sectors able to be withdrawn radially apart to enable the preform 9 to be extracted. The lower die part 30 has an inner surface 30a arranged to form the outer surface of the hollow body 92 of the preform, and comprises a lower end portion and a virtually cylindrical lateral portion. The upper die part 20 and lower die part 30 are separated during the loading of the charge 8, which is inserted into the cavity of only the lower die part 30; the inner surfaces 21 and 30a of said upper die part 20 and lower die part 30 form the entire die cavity when associated operatively with each other.

According to the invention, the lower die part 30 comprises a first constituent member 31 and a second constituent member 32 having inner surfaces 33 and 34 respectively which can be complementarily aligned to together define the entire inner surface 30a of the lower die part 30. The first constituent member 31 presents a through aperture 35 which opens into the die cavity, and of which the inner surface is formed from parallel generators; the second constituent member 32 has a lateral surface which mates with the surface of said through aperture 35 to form a connection which is sealed and allows sliding in the direction of the generators.

According to the embodiment shown in the figures, the cavity of the lower die part 30 is of axial geometric shape. In particular the entire die cavity is of generally quasi-cylindrical shape, the inner surface 30a of the lower die part 30 being of axially symmetrical form (about a vertical axis V) composed of a quasi-cylindrical portion to which a substantially spherical cap-shaped lower portion is joined. These shapes can obviously be different; in particular the lower portion can be of more or less flat shape, instead of spherical cap shape.

The first component 31 of the lower die part 30 is of generally cylindrical shape with its axis coinciding with the axis A, said through aperture 35 also being of cylindrical shape coaxial with the axis A.

Consequently the second constituent member 32 also has a lateral surface of generally cylindrical shape, its inner surface 34 defining the central and lower portion of the inner surface 30a of the lower die part 30.

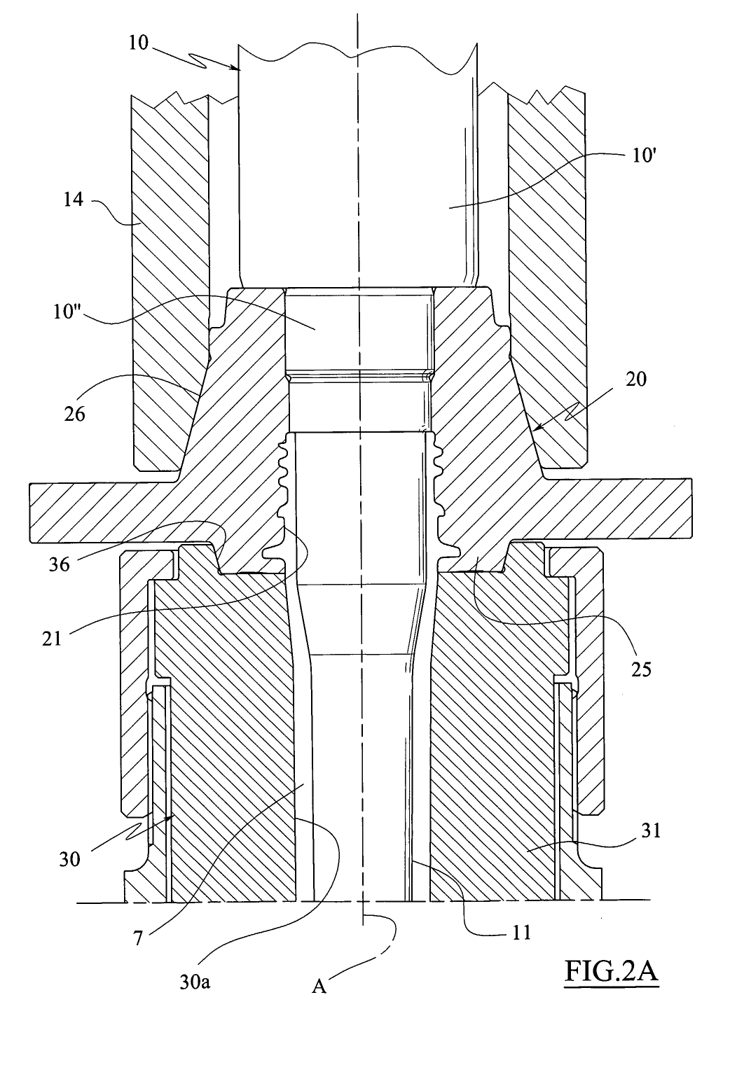

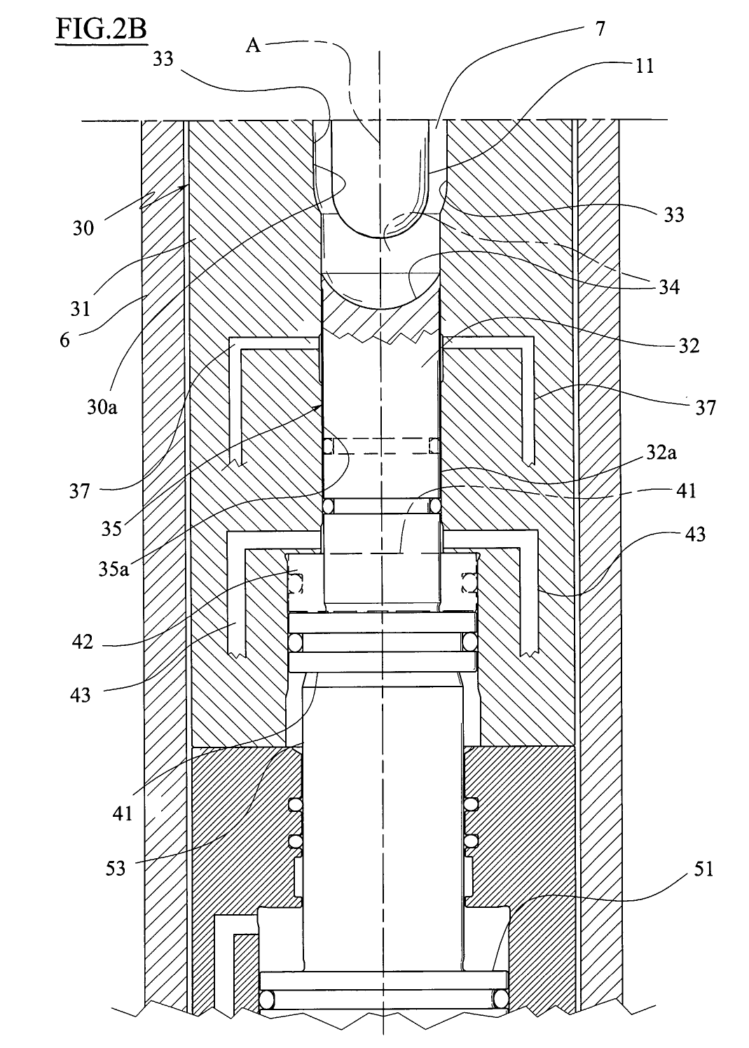

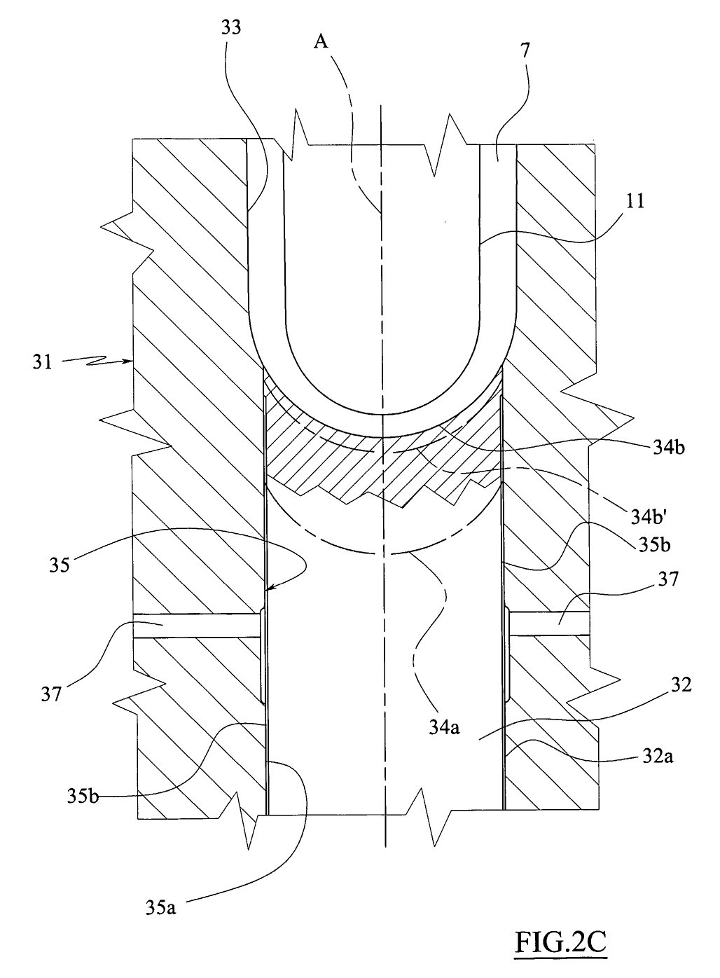

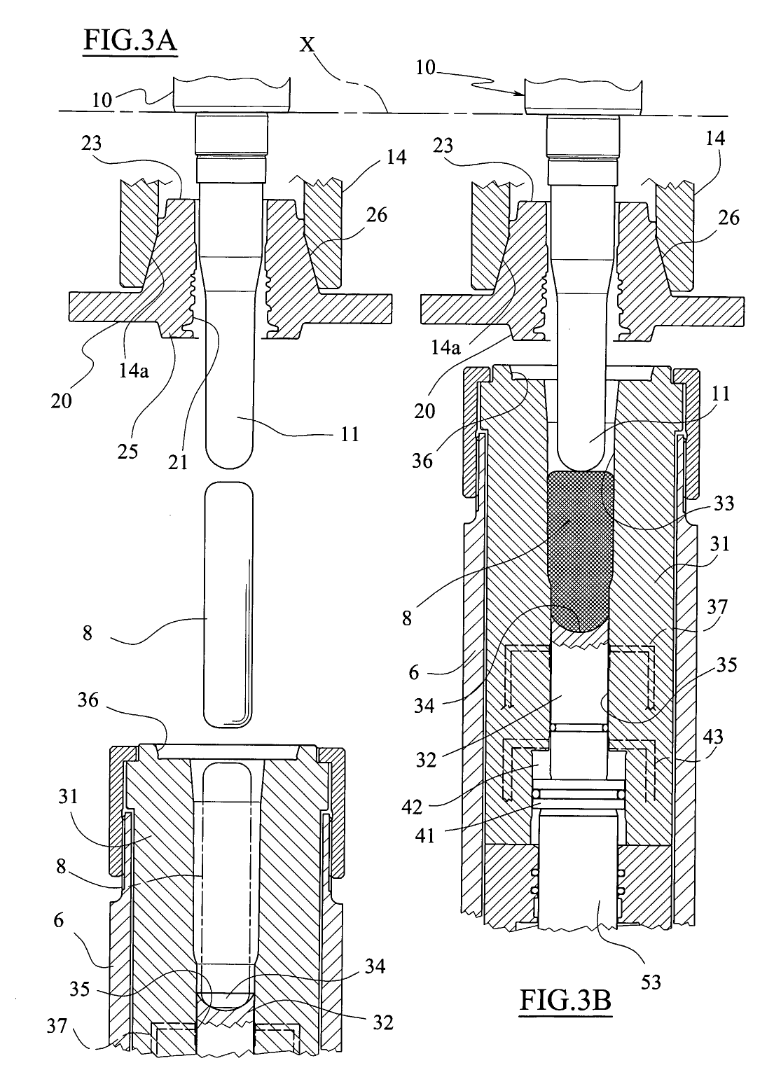

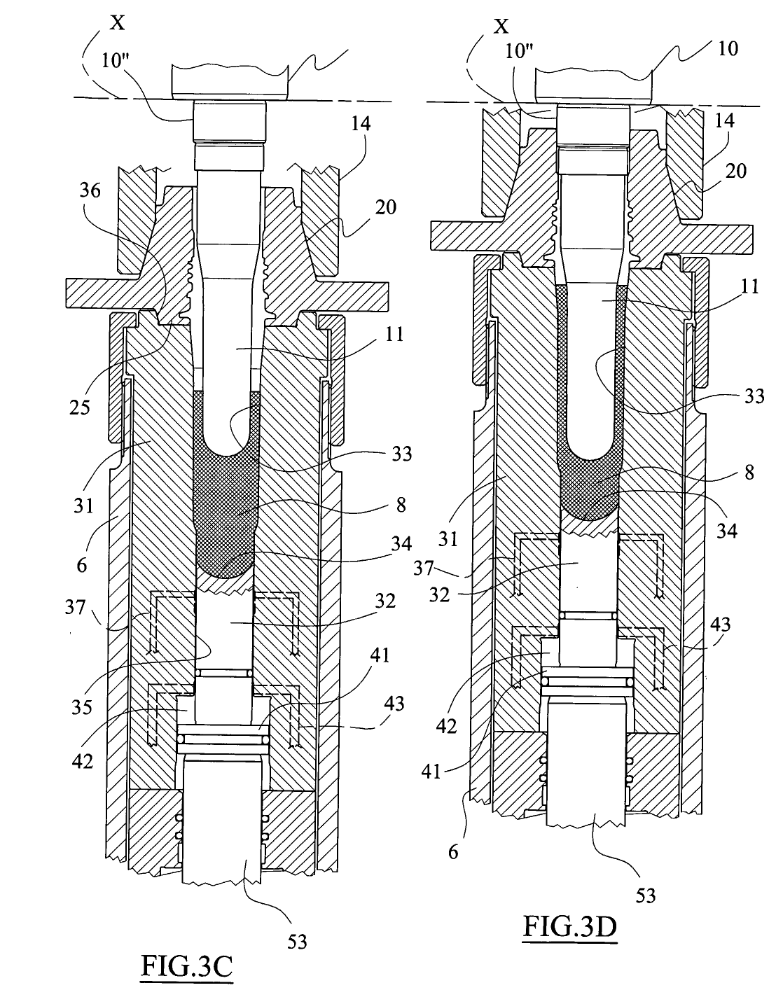

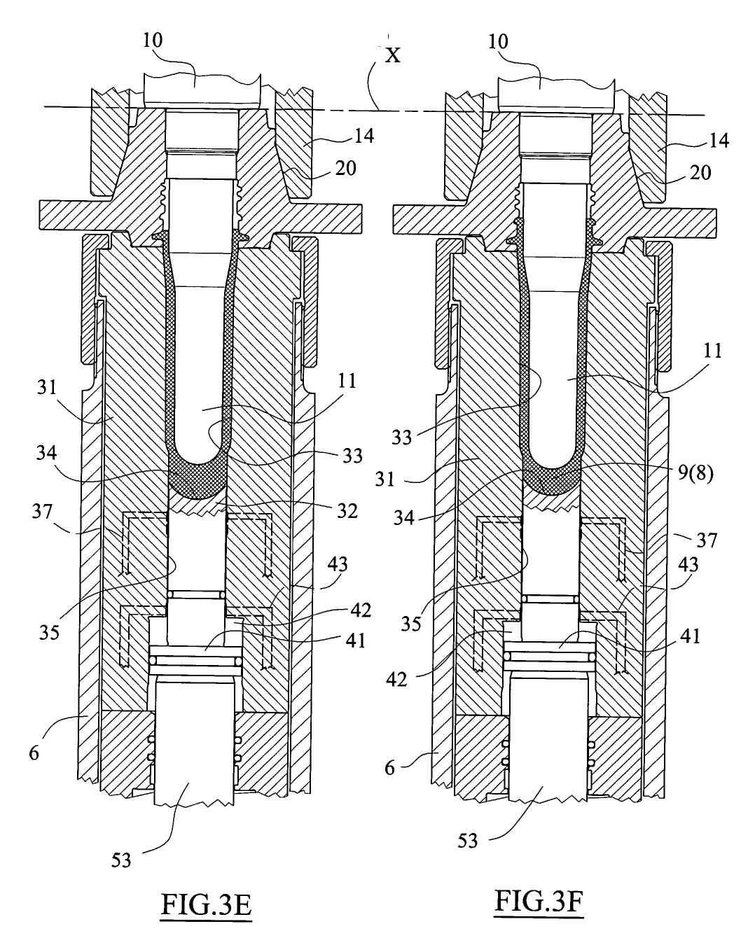

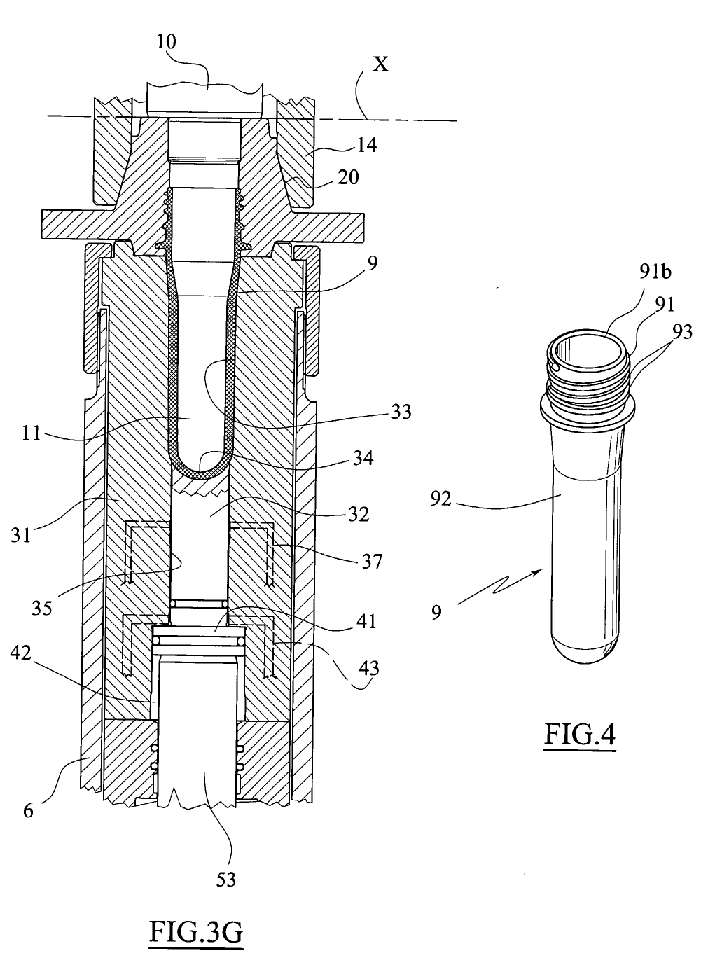

The second constituent member 32 is movable relative to the first constituent member 31 between an upper position (shown in FIG. 3G and by dashed lines in FIG. 2B), in which its inner surface 34 lies in said position aligned with the inner surface 33 of the first constituent member 31, and a withdrawn position in which its inner surface 34 is spaced downwards from the inner surface 33 of the first constituent member 31 to increase the volume of the cavity relative to its volume in the upper position. The term “aligned position” means that the two surfaces 33 and 34 are disposed such that between them there is no substantial discontinuity, as if it were a single surface not separated into two parts. It should be noted that the upper position does not necessarily coincide with the position in which the surface 34 of the second constituent member 32 represents the exact geometrical continuation of the surface 33 of the other constituent member 31 (this is the nominal design position and is is illustrated by full lines in FIG. 2C where it is indicated by 34b) but, as described below, deviates from this in a variable manner, based on the error in the charge mass compared with the predetermined design value. This upper position hence lies below the nominal position 34b (as illustrated by dashed lines and indicated by 34′ in FIG. 2C), if the mass of the charge is greater than the predetermined theoretical value. In practice, it is preferable to ensure that the mass of the charge is never less than the predetermined design value. The so-called upper position is consequently a variable position (which changes in practice at each moulding cycle) close to said nominal position 34b of geometric continuation of the surface 33. A geometric discontinuity between the surfaces 33 and 34 therefore occurs but is of such an extent as to be virtually irrelevant.

The inner surface 34 defines the entire or a large part of the lower end portion of the inner surface of the lower die part. The term “part” means a percentage of the surface, and “a large part” means a percentage sufficient to define, when the second constituent member 32 is in its withdrawn position, a substantial volume increase such as to receive the lower part of the charge 8. In practice said part is at least equal to 50% of the surface of the cavity cross-section.

On the inside and/or the outside of the first constituent member 31 and possibly of the second constituent member 32 suitable canalizations can be provided (i.e. systems with one or more channels) (of known type and not shown herein) to provide for cooling the mould parts and hence the preform.

The unit of the invention also comprises drive means for positioning the second constituent member 32 in said withdrawn position (illustrated by full lines in FIG. 2B) for loading a charge of polymer material into the cavity of the lower die part and to bring it to its upper position (shown in FIG. 3G and by dashed lines in FIG. 2B) for moulding.

In particular, said drive means comprise at least one linear cylinder-piston actuator means.

In the embodiment shown in the figures a linear actuator means is provided comprising a first piston 41, coaxial to the axis A, applied directly to the lower end portion of the second constituent member 32 (in particular formed in one piece therewith), sealedly movable within a chamber 42 provided in the lower region of the first constituent member 31.

The canalization 43, connected to a source (not shown in the figures) of operating fluid (for example compressed air), carries this fluid into the upper region of the chamber 42 to cause the second constituent member 32 to descend downwards and hence bring it into its withdrawn position. Advantageously, said operating fluid can consist of a coolant fluid fed under pressure, to hence perform the further function of cooling the constituent member 32 and with it the moulded article.

A double-acting second actuator means 50 is also provided, disposed below the lower die part 30 and joined to it, it comprising a piston 51 movable within a chamber 52 and with a connected piston rod 53 which pushes against the lower end of the piston 41. An upper canalization 55, connected to a source (not shown in the figures) of operating fluid (for example oil, nitrogen, etc.), carries this fluid into the upper region of the chamber 52 to cause the piston 51 to descend; this descent is preferably effected independently of the descent of the second constituent member 32 produced by the canalization 43 and possibly before this latter.

In addition, a lower canalization 56 connected to a source (not shown in the figures) carries a high pressure operating fluid (e.g. oil, liquid nitrogen, etc.) into the lower region of the chamber 52 to cause the piston 51 and consequently the second constituent member 32 to rise and hence bring this into its upper position.

The upper die part 20 is of traditional type and is divided into at least two mutually complementary sectors (not shown in detail in the figures), able to be withdrawn in a transverse direction to enable the preform to be extracted; when in their closed position, these sectors intimately adhere together at respective matching separation surfaces substantially lying in axial planes.

In the embodiment shown in the figures, the lower face of the upper die part 20 possesses a downwardly directed annular central projection 25 having a frusto-conical convex outer surface mating exactly with an identical conical surface 36 provided on the upper end portion of the first constituent member 31.

When the upper die part 20 is engaged with the lower die part 30, said central projection 25 engages the surface 36 to create, following an axial thrust tending to unite the two die parts 20 and 30, a bond which prevents radial movement of the sectors forming the upper die part 20. When in this configuration, the inner surfaces 21 and 30a of the two die parts are mutually aligned and give rise to a total die surface which shapes the outer surface of the preform. In detail, the two die parts 20 and 30 are spaced axially apart by a small precise amount, to achieve good mutual closure of the frusto-conical surfaces and enable air to leave the mould but without producing leakage of plastic material.

The punch 11 is rigidly fixed to an upper body 10 with which it is formed as one piece and of which it defines the lower end portion, i.e. that which shapes the inner surface of the preform. In detail, the upper body 10 comprises a cylindrical upper portion 10′, the lower end of which forms a shoulder which comes into abutment against the upper end 23 of the upper die part 20, and a lower portion 10″ to which the actual punch 11 is lowerly joined.

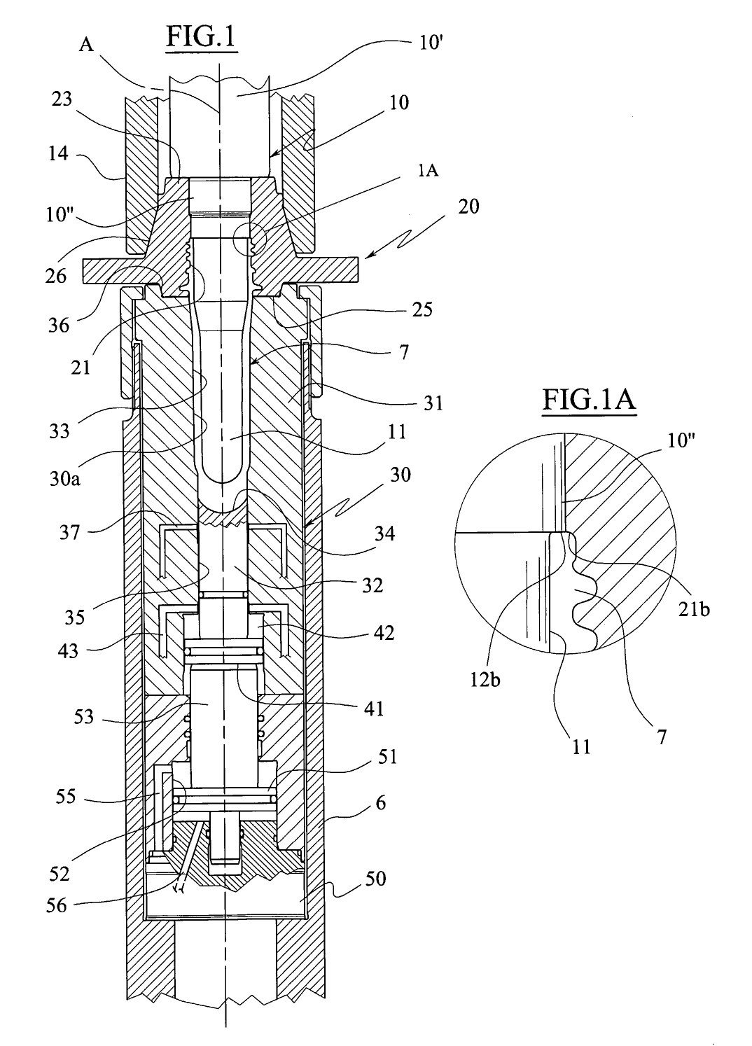

The upper surface 91b of the end upper edge of the preform neck 91 is formed partly by a downwardly facing narrow upper surface 21b terminating with a substantially horizontal tangent defining the upper boundary of the inner surface 21 of the upper die part 20, and partly by a downwardly facing narrow upper surface 12b terminating with a substantially horizontal tangent defining the upper boundary of the outer surface of the punch 11, bordering the lower end of the lower portion 100″ (see FIG. 1A).

When the mould is in its closed position, i.e. the punch 11 and the die parts 20 and 30 are mutually engaged so that the mould cavity (chamber 7) defines the shape of the preform, the two said upper surfaces 12b and 21b are mutually aligned

FIGS. 3A to 3G show a succession of stages in a moulding method according to the invention.

In the embodiment shown in the figures, the mould components are made to approach each other by raising the lower die part 30 by means of a lower device 6 of which only the upper end portion can be seen in the figures; the upper body 10 and the punch 11 are instead at rest. In FIGS. 3A to 3G, X indicates a horizontal reference axis which remains fixed, it passing through the lower abutment shoulder of the upper portion 10″ of the body 10.

That which is however important here is evidently the mutual approach movement; alternatively this can be achieved by downwardly moving the upper body 10, possibly together with an upward movement of the lower device 6.

In an initial stage (shown in FIG. 3A) a charge 8 is inserted into the cavity of the lower die part 30 while the second constituent member 32 is in its withdrawn position.

Following an upward movement of the lower die part 30 (FIG. 3B) produced by the device 6, the punch 11 penetrates progressively into the die cavity and begins to deform the charge 8; during this stage a vertical action is exerted on the charge tending to facilitate total filling of the space generated by the second constituent member 32 in its withdrawn position. Together with the penetration of the punch, the upper end of the lower part 30 approaches and finally engages the lower end of the upper die part 20 (position shown in FIG. 3C).

The sectors forming the upper die part 20 are locked in a radially closed position by an upper annular member 14 (of known type) associated with the punch 11 and movable vertically thereto, its lower end portion possessing a frusto-conical concave surface 14a which mates with a complementary upper outer lateral surface 26 of the upper die part 20, also frusto-conical.

The punch 11 then continues (FIG. 3D) to penetrate (by the continued upward movement of the lower device 6) into the die cavity until complete mould closure is achieved, this occurring when the two surfaces 12b and 21b are aligned (position shown in FIG. 3E).

The second constituent member 32 is then also moved upwards (FIG. 3F) by the described drive means, until its inner surface 34 is brought into said upper position (position shown in FIG. 3G).

According to one aspect of the invention, the unit of the invention comprises a mould having a lower die part 30 arranged to form at least the lower part of the outer surface of the article, the inner surface 30a of which comprises a lower end portion and a lateral portion of axial extension, the insertion of the punch into the cavity of the lower die part commencing before closure of the cavity.

For most of its axial length, the inner surface 30a of the lower die part 30 is of substantially cylindrical shape (i.e. cylindrical or quasi-cylindrical) with vertical or nearly vertical generators, and has a diameter less than one half of the total axial dimension of the mould cavity (i.e. the axial dimension of the inner surface 21 plus the axial dimension of the inner surface 30a).

To ensure that the charge descends into the cavity of the lower part 30 without coming into contact with the inner surface 30a (except for its bottom surface), the charge while descending into the mould must have a maximum diameter rather smaller (good results have been obtained with values between 90% and 80%) than the diameter of said cylindrical part of the surface 30a, to provide sufficient geometrical clearance to ensure the descent. Consequently, the axial length of the charge, during that stage in which it penetrates into the cavity of the lower die part, can be greater than the axial length of the cavity when said second constituent member 32 is in its upper position.

However, in that stage in which the die receives the charge 8 (the second constituent member 32 is in its withdrawn position), the cavity of the lower die part 30 presents an axial length greater than the axial length of the charge, because in addition the inner surface 34 of the second constituent member 32 is relatively large, and specifically such as to contain the lower portion of the charge, and the volume of the cavity of the lower die part 30 is sufficient to completely contain the charge, such that its upper level is sufficiently below the line of closure between the upper die part 20 and the lower die part 30. FIG. 3A shows by dashed lines the charge 8 at that moment in which it reaches the bottom of the cavity. To facilitate insertion of the charge, this can have a conveniently profiled/tapered lower end.

This can be achieved by manipulation/insertion means.

The length of the cavity of the lower die part 30 according to the invention becomes substantially greater than that of a traditional die and enables a charge to be received having a relatively large mass and diameter somewhat smaller than the cavity, which otherwise would not be receivable.

This aspect is particularly advantageous if moulding preforms comprising (as shown in FIG. 4) an upper neck 91 provided with projections, and a hollow body 92 joined to the neck 91, in which the unit (as illustrated in the figures) comprises a mould having: an upper die part 20 with its inner surface forming the outer surface of the upper neck 91, and a lower die part 30, defined by said hollow body, with its inner surface 30a forming the outer surface of the hollow body 92, said inner surface 30a comprising a lower end portion and a virtually cylindrical lateral portion, said upper die part 20 and lower die part 30 forming the die cavity when mutually associated operatively.

This is particularly the case if the unit is applied, individually or with a plurality of other units, in a rotating turntable machine in continuous operation.

In this respect, with units having these characteristics, as already described in detail in the introduction, it is particularly difficult using the traditional method to insert a charge into the die cavity, hence the charge to be inserted into the cavity must generally have a diameter particularly smaller than the cavity itself, with the result that it tends to project considerably from the cavity.

This advantageous aspect also operates in the moulding stage when the punch penetrates into the mass of the charge, to deform it; in this respect, because of the presence of an increased volume at the lower end of the cavity, into which the charge is fed, its highest parts remain a sufficient distance from the upper limit of the die cavity 7, while the punch descends into the cavity (FIGS. 3C and 3D) until the cavity 7 is completely closed (FIG. 3E). This prevents parts of the charge from being able to escape upwards from the cavity of the lower die part 30 before the upper die part 20 and lower die part 30 have come together (FIG. 3C), with the risk of forming unacceptable burrs, and prevents parts of the charge from being ejected upwards out of the die before this is completely closed (FIG. 3E).

According to one aspect of the invention, the commencement of the described movement of the second constituent member 32 towards its upper position lags behind the penetration of the punch so that parts of the charge are unable to escape from the die cavity before this is completely closed. In particular, it is preferable that this movement of the second constituent member 32 begins after the punch has reached said mould closure position (FIG. 3E).

Having reached the described final position (upper position—FIG. 3G), the second constituent member 32 is advantageously maintained pressed against the material lying in the mould cavity with a predetermined design pressure, for a period in which the material of the preform undergoes considerable cooling with consequent volume reduction following reduction of the specific volume.

In this manner, material shrinkage takes place with a corresponding reduction in the volume of the cavity under pressure, with consequent compacting of the material into the more appropriate volume. The result is that, as found experimentally, the final article presents a more compact, uniform mass without irregularities and dangerous internal stresses. Moreover, maintaining the pressure on the material for the entire moulding stage (cooling included) allows more effective cooling by the effect of better heat transfer between the material and the various mould parts which are themselves cooled.

Said design pressure is usually of the order of a few hundreds bars; indicatively, the moulding time between stage 3B and stage 3G is of the order of some tenths of a second, the subsequent time for which the working pressure is maintained being a few seconds. Another important advantage obtained by the invention is that, if the mass of the charge 8 presents an error relative to a predetermined value, as happens in practice, the mould cavity is still filled perfectly, this being achieved at the desired design pressure (this aspect is important especially with regard to the neck 91 which represents the most critical region, as this undergoes its definitive moulding).

In this respect it happens that the second constituent member 32, at the end of the moulding stage, halts in a position (upper position) in which it is spaced to a greater or lesser extent from said position of exact geometric continuation between the surfaces 33 and 34, depending on the extent of the charge error (and also on the operating pressure). Consequently, that preform part which absorbs the variations in the mass of the charge 8 is the part formed by the surface 34 of the second constituent member 32; in practice, the lower end region of the preform hollow body 92 assumes a thickness which is either greater than the design thickness (line 34b′ in FIG. 2C) or equal to the design thickness (line 34b) depending on whether the charge has a mass greater than or exactly equal to the predetermined mass.

In the next or stretch blow moulding stage, as the hollow body 92 is strongly expanded (while the neck 91 remains unaltered), the fact that the lower portion of this body has a thickness not exactly equal to the design thickness is generally acceptable. Moreover the charge error is so small compared with the dimensions of the article part into which it is absorbed, that said difference between the actual thickness and the design thickness is practically irrelevant and certainly acceptable.

According to another aspect of the invention, means are provided for feeding and/or drawing pressurized fluid into and/or from the mould cavity which advantageously use the interstice present between the lateral surface 32a and the inner surface 35a of said through aperture 35, and which is produced with usual clearance to enable the two surfaces 32a and 35s to slide relative to each other. The engagement between said surfaces has a sufficiently small clearance to act as a seal against any seepage of polymer material from the charge which is sufficiently large to enable gas (air) or other fluids to pass.

In addition to the usual clearance to allow sliding, the interstice between the lateral surface 32a and the inner surface 35a can comprise thin axial grooves 35b, for example provided in the cylindrical surface of the body 32, their upper end stopping a short distance below the upper edge of the aperture 35, and serving to facilitate fluid passage.

In particular, in the first constituent member 31 there is provided a canalization (i.e. a system with one or more channels) 37 which opens into the through aperture 35 and is connected to means for drawing out the air present in the mould cavity through the interstice present between said surfaces 32a and 35a. Through said canalization, air can be extracted from the mould cavity before and during moulding.

Said canalization 37 (or another parallel canalization) can also be connected to means (not shown in the figures) for supplying a pressurized fluid, which are operated during extraction of the preform from the mould after its moulding, to facilitate detachment of the preform from the lower die part 30.

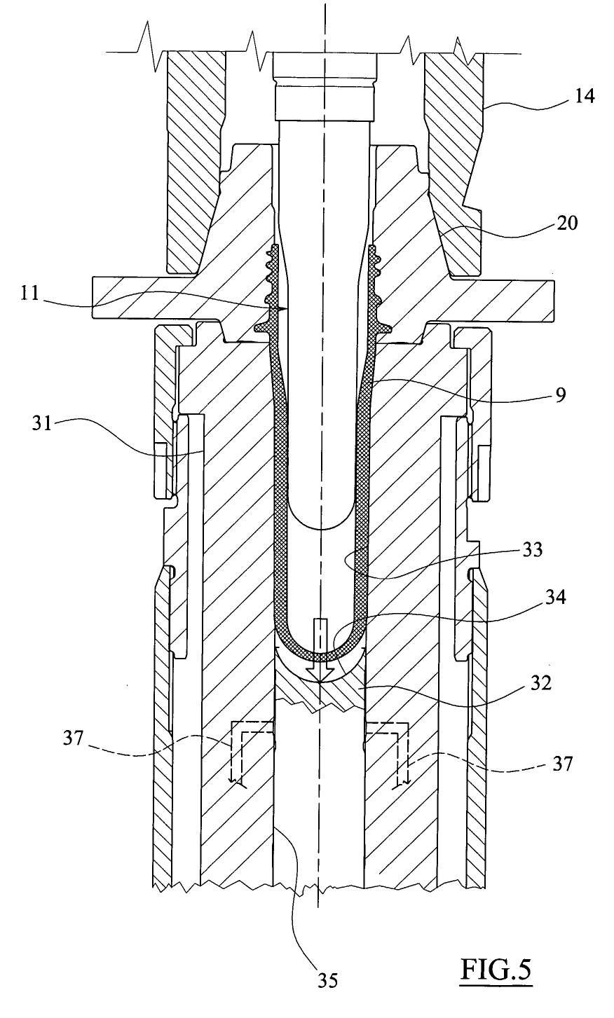

FIG. 5 shows a stage of detaching the preform from the die after the preform has been moulding and initially partly cooled. During this stage the punch 11 has already been partly extracted from the preform while this is maintained rigid with the two die parts 20 and 30.

To now also detach the preform from the die while the preform is held at rest relative to the lower die part (for example by clamping the preform neck 91 between the sectors forming the upper die part 20 which itself is held at rest relative to the lower die part 30), the second constituent member 32 is pulled downwards away from the lower die part 30, in particular by the action of a pressurized fluid fed into the chamber 42; at the same time a fluid is fed at a correct pressure into the canalization 37 by said means; this fluid penetrates through the interstice present between the lateral surface 32a and the inner surface 35a and into the lower end region of the die cavity, between the lower part of the surface 30a and the lower surface of the preform, to prevent a vacuum forming in this region; it therefore facilitates downward movement and hence detachment of the second constituent member 32 from the lower part of the preform (see FIG. 5); finally, it facilitates subsequent complete detachment of the lower portion of the preform from the entire lower die part. This fluid fed into the cavity of the lower die part 30 can also be temperature controlled at a temperature suitable for contributing to the first cooling stage of the moulded preform.

The units of the invention can be fixed to the moulding machine so that they always remain thereon. Alternatively, they can be incorporated into independent shuttles movable independently of each other, to be manipulated and operated by the moulding machine, and to then leave the machine to follow paths external to it.

The two die parts, i.e. the lower and upper, can be rigidly joined together. Numerous modifications of a practical and applicational nature can be made to the unit of the invention, but without leaving the scope of the inventive idea as claimed below.

1. A unit for compression moulding articles of polymer material by coupling together under pressure a punch (11) and a die to form a closed cavity loaded with a charge of polymer material, the charge being initially produced outside the die and then inserted into the die cavity,
the unit comprising a mould having a die, of which a lower part (30) is arranged to form at least the lower part of the outer surface of the article, the inner surface (30a) of which comprises a lower end portion and an axially extending lateral portion,
characterised in that the lower die part (30) comprises a first constituent member (31) and a second constituent member (32) having inner surfaces (33, 34) which can be complementarily aligned to together define the inner surface (30a) of the lower die part (30), the inner surface (34) of the second constituent member (32) defining totally or to a large extent said lower end portion of the inner surface of the lower die part (30),
said second constituent member (32) being movable relative to the first constituent member (31) between an upper position in which its inner surface (34) lies in said position aligned with the inner surface (33) of the first constituent member (31) and a withdrawn position in which its inner surface (34) lies distant from the inner surface (33) of the first constituent member (31) in order to increase the volume of the cavity of the lower die part (30),
and further comprising drive means to dispose said second constituent member (32) in said withdrawn position during the stage of loading a charge of polymer material into the cavity of the lower die part (30) and to bring it into its upper position during the moulding stage.

2. A unit as claimed in claim 1, characterised in that said first constituent member (31) of the lower die part (30) has a through aperture (35) which opens into the die cavity, and has parallel generators, said second constituent member (32) having a lateral surface (32a) which mates with the inner surface (35a) of said through aperture (35) to form a connection which is sealed against passage of molten polymer material and allows sliding in the direction of the generators.

3. A unit as claimed in claim 2, characterised by comprising means for feeding and/or drawing pressurized fluids into and/or from the mould cavity through the interstice present between the lateral surface (32a) and the inner surface (35a) of said through aperture (35) in contact with it.

4. A unit as claimed in claim 3, characterised by comprising a canalization (37) which opens into the through aperture (35) and is connected to means for drawing out the air present in the mould cavity.

5. A unit as claimed in claim 3, characterised by comprising a canalization (37) which opens into the through aperture (35) and is connected to means for feeding a pressurized fluid into the mould cavity, between the surface (30a) of the lower die part (30) and the lower surface of the article, to facilitate mutual separation of said surfaces, and which are operated after moulding.

6. A unit as claimed in claim 5, characterised in that said pressurized fluid fed into the mould cavity is temperature controlled to provide a first cooling stage of the article just moulded.

7. A unit as claimed in claim 1, characterised by comprising a canalisation on the inside and/or the outside of the second constituent member (32), for cooling the article.

8. A unit as claimed in claim 2, characterised in that said constituent member (32) and said through aperture (35) have a cylindrical lateral surface.

9. A unit as claimed in claim 2 in which the cavity of the lower die part (30) is of axial geometric shape, characterised in that said through aperture (35) is coaxial with the cavity of the lower die part (30), the inner surface (34) of the second constituent member (32) defining the central and lower portion of the inner surface of the lower die part (30).

10. A unit as claimed in claim 1, characterised in that said drive means for the second constituent member (32) comprise at least one linear actuator of cylinder-piston type.

11. A unit as claimed in claim 10, characterised in that said linear actuator means comprises a piston (41) applied directly to the lower portion of the second constituent member (32) and sealedly movable within a chamber (42) fixed to the lower portion of the first constituent member (31).

12. A unit as claimed in claim 1, in which, during moulding, the insertion of the punch into the cavity of the lower die part (30) commences before closure of the cavity, and wherein:
for most of its axial length, the inner surface (30a) of the lower die part (30) is of substantially cylindrical shape with substantially vertical generators, and has a diameter less than one half of the total axial dimension of the mould cavity,
and the axial length of the charge, during that stage in which it penetrates into the cavity of the lower die part, can be greater than the axial length of the cavity when said second constituent member 32 is in its upper position, whereas it is less than the axial length of the cavity when the second constituent member is in its withdrawn position.

13. A unit as claimed in claim 12, wherein during its descent into the mould, the charge possesses a maximum diameter sufficiently less than the diameter of said cylindrical part of the surface (30a).

14. A unit as claimed in claim 12, for moulding container preforms of polymer material, the preforms comprising an upper neck (91) provided with projections, and a hollow body (92) joined to the neck (91), wherein the unit comprises a mould having:
an upper die part (20) with its inner surface (21) arranged to form the outer surface of the upper neck (91),
a lower die part (30) with its inner surface (30a) arranged to form the outer surface of the hollow body (92), said inner surface (30a) comprising a lower end portion and a virtually cylindrical lateral portion,
said upper die part (20) and lower die part (30) forming the die cavity when operationally associated with each other.

15. A unit as claimed in claim 14, wherein the unit is applied, individually or with a plurality of other units, in a rotating turntable machine continuously in operation, in which the moulding units are operated in sequence.

16. A method for compression moulding container preforms of polymer material by the unit of claim 1, characterised by comprising the following stages:
preparing a charge outside the die;
inserting the charge into the cavity of the lower die part (30) with the second constituent member (32) in its withdrawn position;
then progressively inserting the punch (11) into the die cavity until the mould is completely closed;
moving the second constituent member (32) into its upper position, this movement starting with a time delay on the punch penetration so that no part of the charge can escape from the die cavity before this is completely closed,
maintaining the second constituent member (32) pressed against the material with a predetermined pressure, for a period in which the preform material undergoes cooling with consequent volume reduction.

17. A method as claimed in claim 16, characterised in that the movement of the second constituent member (32) into its upper position commences not before the punch (11) reaches the mould closure position.

18. A method for compression moulding container preforms of polymer material by the unit of claim 5, characterised in that, after moulding the preform, while the preform is held at rest relative to the lower die part the second constituent member (32) is pulled downwards away from the lower die part (30) while at the same time feeding pressurized fluid between the lower part of the inner surface (30a) and the article, to induce detachment of the second constituent member (32) from the lower part of the article.
